(19) United States
(12) Patent Application Publication
(10) Pub. No.: US 2018/0124025 A1
(43) Pub. Date: May 3, 2018

(54) PROVIDING VISIBILITY INTO ENCRYPTED TRAFFIC WITHOUT REQUIRING ACCESS TO THE PRIVATE KEY

(71) Applicant: Riverbed Technology, Inc., San Francisco, CA (US)

(72) Inventors: Blanco Zee Leung Lam, Rancho Palos Verdes, CA (US); Javier Rodriguez, San Jose, CA (US)

(73) Assignee: Riverbed Technology, Inc., San Francisco, CA (US)

(21) Appl. No.: 15/799,905

(22) Filed: Oct. 31, 2017

Related U.S. Application Data
(60) Provisional application No. 62/415,328, filed on Oct. 31, 2016.

(51) Int. Cl. H04L 29/06

(52) U.S. Cl. CPC H04L 63/0471; H04L 63/061; H04L 63/0435; H04L 63/166; H04L 63/0485; H04L 63/0281

(57) ABSTRACT

Systems and techniques are described for providing visibility into encrypted traffic without requiring access to the private key. Some embodiments can transparently intercept a secure connection handshake that establishes a secure connection between a client and a server, wherein during said transparently intercepting the secure connection handshake, the embodiments can (1) obtain connection information associated with the secure connection, and (2) obtain a session key that the client and server agree on during the secure connection handshake. The connection information and the session key can then be stored in a database, thereby providing visibility into encrypted traffic without requiring access to the private key.

### RELATED APPLICATION

This application claims benefit of U.S. Provisional Patent Application No. 62/415,328, filed 31 Oct. 2016, the contents of which are herein incorporated by reference in their entirety for all purposes.

### BACKGROUND

The present disclosure relates to data communication networks. More specifically, the present disclosure relates to providing visibility into encrypted traffic without requiring access to the private key. Data communication networks include a variety of network devices for sending, receiving, directing, and optimizing network data traffic. According to one definition, a network is an interconnection of one or more devices that is capable of delivering information from one network node to another network node. A network node can generally refer to any device that is capable of sending and/or receiving data over a network. Examples of networks include, but are not limited to, wireless and wired networks, local area networks (LANs), metropolitan area networks (MANs), wide area networks (WANs), private networks, public networks, intranets, the Internet, etc.

FIG. 1 illustrates a network. Client site 102 can be a company's headquarters or a company's regional office. Cloud computing provider 108 can host servers and data storage systems that are used to provide Infrastructure as a Service (IaaS), Software as a Service (SaaS), Platform as a Service (PaaS), or any other cloud computing service. Client site 102 can include one or more clients (e.g., clients 104-1 and 104-2), and networking devices (e.g., router 106). Likewise, cloud computing provider 108 can include one or more servers (e.g., servers 110-1 and 110-2), and networking devices (e.g., router 112). Communication between client site 102 and cloud computing provider 108 can occur over network 114. The number and types of devices shown in FIG. 1 are for illustration purposes only and are not intended to limit the scope of this disclosure.

In a typical use case for a cloud computing service, client 104-1 establishes secure connection 116 with server 110-1. The cloud computing service is then provided over secure connection 116. In order to ensure data security and integrity, traffic over secure connection 116 is typically protected by using a cryptographic protocol, such as Secure Sockets Layer (SSL) or Transport Layer Security (TLS). If the same company owned both client 104-1 and server 110-1, then the company would have access to the private key of server 110-1 which was used for establishing secure connection 116. The company could then use the private key to provide visibility into the encrypted traffic on secure connection 116.

However, the problem with the cloud computing provider example shown in FIG. 1 is that the owner of client site 102 is different from the cloud computing provider. Thus, the owner of client site 102 no longer has visibility into the data that is entering or exiting client site 102. This raises many security issues, one of which is that the company that owns client site 102 can no longer detect whether any sensitive or confidential information is being communicated outside the company.

One solution is to use a proxy server or firewall to decrypt and inspect the encrypted traffic. The problem with this approach is that most proxy servers are designed for web-based traffic, but not all applications are web-based. For example, Microsoft® Outlook® uses SSL but it is not a web-based application. In fact, some cloud computing providers specifically recommend bypassing proxy servers due to scalability concerns. Another problem is that current solutions (e.g., proxy servers) can inspect traffic in real time, but they are not designed to inspect traffic retrospectively. For example, if a confidential information leakage incident happened a week ago, and a customer wanted to “replay” the traffic as part of an investigation, then that is not possible using current solutions.

### SUMMARY

Some embodiments described herein provide techniques and systems for providing visibility into encrypted traffic without requiring access to the private key. Some embodiments can transparently intercept a secure connection handshake that establishes a secure connection between a client and a server, wherein while transparently intercepting the secure connection handshake, the embodiments can (1) obtain connection information associated with the secure connection, and (2) obtain a session key that the client and server agree on during the secure connection handshake. The agreed-on session key is then used by the client and server to encrypt packets that are sent over the secure connection.

Next, the encrypted packets exchanged between the client and the server over the secure connection can be captured and stored. The encrypted packets can then be decrypted by using the session key to obtain decrypted packets. Next, the decrypted packets can be analyzed.

In some embodiments, analyzing the decrypted packets can comprise searching for words or phrases in the decrypted packets that indicate that the encrypted packets contained confidential information.

In some embodiments, the connection information and the session key can be stored in a first database so that the session key can be looked up based on the connection information. In some embodiments, the connection information and the encrypted packets can be stored in a second database so that the encrypted packets can be looked up based on the connection information. In some embodiments, decrypting the encrypted packets can comprise (1) retrieving the session key by performing a look up on the first database by using the connection information, and (2) retrieving the encrypted packets by performing a look up on the second database by using the connection information.

### BRIEF DESCRIPTION OF THE FIGURES

FIG. 1 illustrates a network.

FIG. 2 illustrates a system for providing visibility into encrypted traffic without requiring access to the private key in accordance with some embodiments described herein.

FIG. 3 illustrates a system for providing visibility into encrypted traffic without requiring access to the private key in accordance with some embodiments described herein.

FIG. 4 presents a flowchart that illustrates a process for providing visibility into encrypted traffic without requiring access to the private key in accordance with some embodiments described herein.

FIG. 5 illustrates an apparatus in accordance with some embodiments described herein.

### DETAILED DESCRIPTION

The following description is presented to enable any person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and scope of the present invention. Thus, the present invention is not limited to the embodiments shown, but is to be accorded the widest scope consistent with the principles and features disclosed herein. In this disclosure, when the term “and/or” is used with a list of entities, it refers to all possible combinations of the list of entities. For example, the phrase “X, Y, and/or Z” covers the following cases: (1) only X; (2) only Y; (3) only Z; (4) X and Y; (5) X and Z; (6) Y and Z; and (7) X, Y, and Z. Additionally, in this disclosure, the term “based on” means “based solely or partially on.”

### Overview

As mentioned above, the decryption of SSL traffic typically requires the possession of the private key. However, this may not always be possible and having the private key won't suffice when dealing with more recent encryption algorithms. Specifically, newer software leverages cryptographic algorithms, such as Elliptic-Curve Diffie-Hellman Ephemeral (ECDHE) key exchanges, making transactions even more secure, and having access to the private key alone will not allow the traffic be decrypted at a later time.

In some embodiments described herein, during the SSL handshake, a key piece of information, known as the master secret, is used to generate what is known as the session key. This session key is then used to encrypt the data between the client and the server. Possession of the session key allows the decryption of the SSL traffic both in real time and retrospectively. Embodiments described herein export the session key via a secure channel to a database so that the session key can be used at a later time for decryption of the SSL traffic even without access to the private key. Application programming interfaces (APIs) may also be provided to allow third parties to obtain this session key, either in real time or to connect to the database.

Providing Visibility into Encrypted Traffic

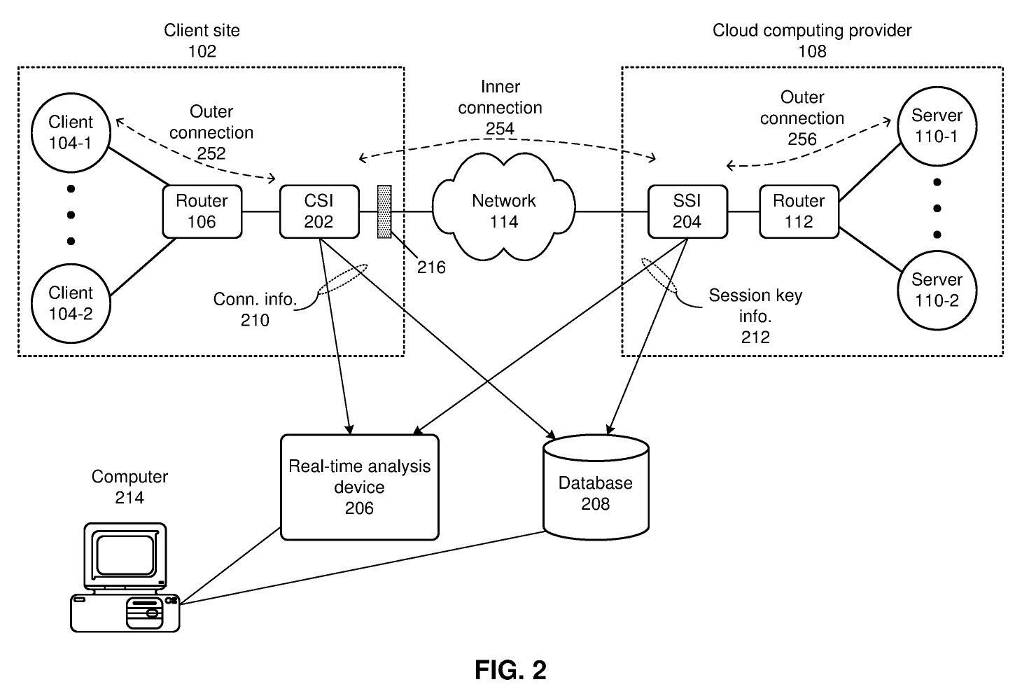

FIG. 2 illustrates a system for providing visibility into encrypted traffic without requiring access to the private key in accordance with some embodiments described herein.

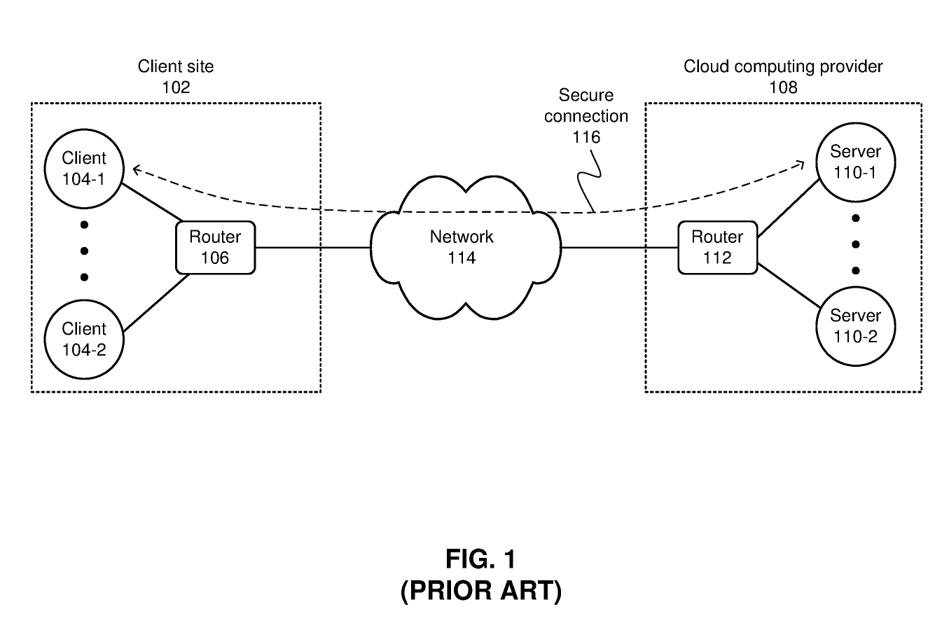

Client-side intermediary (CSI) device 202 and server side intermediary (SSI) device 204 can be used to optimize secure connections between clients in client site 102 and servers in cloud computing provider 108. Specifically, CSI 202 and SSI 204 can transparently intercept messages that are exchanged during secure connection establishment, and create three secure connections: a first outer connection between a client and CSI 202, an inner connection between CSI 202 and SSI 204, and a second outer connection between SSI 204 and a server. The interception may be performed transparently, i.e., the client and the server may communicate with each other as if they had established an end-to-end connection without realizing that, in fact, the end-to-end connection was split into multiple connections by the intermediary devices. For example, secure connection 116 (shown in FIG. 1) between client 104-1 and server 110-1 can be transparently split-terminated by CSI 202 and SSI 204, thereby creating outer connections 252 and 256, and inner connection 254.

During the process of split-terminating the secure connection between client 104-1 and server 110-1, SSI 204 impersonates server 110-1, and negotiates the SSL handshake with client 104-1. Note that client 104-1 believes that it is communicating with server 110-1. In this manner, SSI 204 obtains session key information 212 that client 104-1 and SSI 204 use for encrypting their communications (the client and server communicate with each other because SSI 204 forwards the traffic both ways). SSI 204 can provide session key information 212 to a real-time analysis device 206, and/or store session key information 212 in database 208 (which can be a secure database). Also, during the process of split-terminating the secure connection between client 104-1 and server 110-1, CSI 202 obtains connection information 210 that client 104-1 and server 110-1 use for communicating with each other. Connection information 210 can include Internet Protocol (IP) addresses, port numbers, and timestamps that indicate the start and end times for the connection. CSI 202 can provide connection information 210 to a real-time analysis device 206, and/or store connection information 210 in database 208. Specifically, database 208 can associate the session key information with the connection information for each secure connection that is transparently intercepted by CSI 202 and SSI 204.

Computer 214 can be used to control real-time analysis device 206, or to analyze the secure connection traffic at a later time. For example, computer 214 can specify an IP address and port number to real-time analysis device 206. Next, real-time analysis device 206 can monitor connection information 210 that is continuously being received from CSI 202 to detect whether a secure connection with the specified IP address and port number has been established. As soon as real-time analysis device 206 detects that a secure connection has been established with the specified IP address and port number, then real-time analysis device 206 can use session key information 212 that was received from SSI 204 to decrypt the secure connection traffic, and perform real-time analysis. Specifically, a packet capture device 216 can be used to capture the encrypted packets, and real-time analysis device 206 can then decrypt the captured packets to perform real-time analysis. For example, the real-time analysis may include searching for sensitive words or phrases to determine whether or not sensitive information is being communicated outside the company.

Computer 214 can also be used to perform offline analysis of the encrypted traffic. Specifically, packet capture device 216 can be used to capture encrypted packets that are sent between the client and server. The encrypted packets can then be stored (e.g., the encrypted packets can be stored in database 208, or in a secure database that is distinct from database 208, or in packet capture device 216 itself) and be associated with the connection information (e.g., IP address, port, and start/end timestamps) and the session key. Next, computer 214 can retrieve the encrypted packets and the session key. Computer 214 can then decrypt the encrypted packet by using the session key, and perform analysis. For example, the offline analysis may include replaying the communication of a secure session to analyze a security incident.

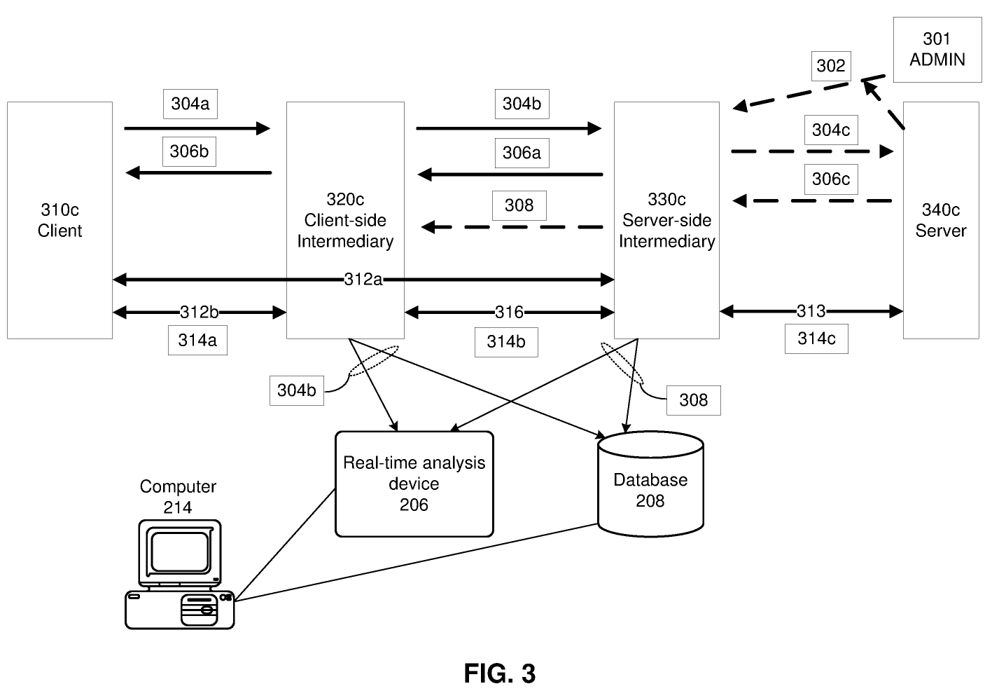

FIG. 3 illustrates a system for providing visibility into encrypted traffic without requiring access to the private key in accordance with some embodiments described herein. Specifically, FIG. 3 illustrates the messages that are exchanged when a secure connection is established, and explains how the server-side intermediary can obtain the session key during this process. Further details of this process can be found in U.S. Pat. No. 8,613,071, entitled “Split Termination for Secure Communication Protocols,” which describes a method for establishing split-terminated communication connections between clients (e.g., client 104-1) and servers (e.g., server 110-1) that are secured using SSL, TLS, or some other appropriate secure communication protocol. In FIG. 3, client 310c can correspond to client 104-1, client-side intermediary 320c can correspond to CSI 202, server-side intermediary 330c can correspond to SSI 204, and server 340c can correspond to server 110-1.

During operation, server-side intermediary 330c receives security information 302, such as encryption keys and digital certificates, from a server 340c or administrative system 301. Security information 302 is sufficient for SSI 330c to assume the identity of server 340c and optionally additional servers. In embodiments, server 340c can provide all or a portion of security information 302 directly to server-side intermediary 330c or another computer system can provide security information 302 to server-side intermediary 330c for server 340c.

Client 310c sends a secure connection request 304a to server 340c via client-side intermediary 320c. Client-side intermediary 320c intercepts secure connection request 304a and in turn forwards the secure connection request 304b to server-side intermediary 330c. In an embodiment, client-side intermediary 320c acts as a bridging device for this forwarding, so that request 304b is similar or identical to 304a. As shown in FIG. 3, client-side intermediary 320c can provide secure connection request 304b to real-time analysis device 206 and/or database 208.

Because the server-side intermediary 330c has security information sufficient to assume the identity of server 340c, server-side intermediary 330c will respond to secure connection request 304b with a secure connection response 306a. Client-side intermediary 320c will intercept the secure connection response 306a and forward secure connection response 306b to client 310c, thereby establishing a secure connection 312a between client 310c and server-side intermediary 330c. Any information sent via this secure connection 312a will be unintelligible to any intervening components, including client-side intermediary 320c. In an embodiment, client-side intermediary 320c acts as a bridging device for this forwarding, so that request 306b is similar or identical to 306a.

In an embodiment, server-side intermediary 330c will also exchange messages 304c and 306c with the server 340c to establish a second secure connection 313 between server-side intermediary 330c and server 340c. In some embodiments, the security protocol of the secure connection 312a, for example SSL, may require a series of messages similar to messages 304 and 306 exchanged between client 310c and server-side intermediary 330c to establish the secure connection. For some security protocols, such as SSL, messages 304 and 306 use public-key cryptography to establish the secure connection 312a. Public-key cryptography is used to share a symmetric key between the client 310c and the server-side intermediary 330c. Once the secure connection 312a is operational, the symmetric key will be used by both sides of the secure connection 312a to encrypt and decrypt information.

Following the establishment of the secure connection 312a between the client 310c and server-side intermediary 330c, an embodiment of server-side intermediary 330c forwards secure connection information 308 to client-side intermediary 320c. Secure connection information 308 enables client-side intermediary 320c to take over the secure connection 312a in place of server- side intermediary 330c. As a result, secure connection 312a, between the client 310c and the server-side intermediary 330c, is transformed into secure connection 312b, between the client 310c and the client-side intermediary 320c.

The secure connection information 308 can include information such as a symmetric key or other type of cryptographic information necessary to decrypt secure connection network traffic from the client 310c and to respond appropriately via the established secure connection. As shown in FIG. 3, the secure connection information 308 can be provided to real-time analysis device 206 and/or database 208.

After secure connection information 308 has been received by the client-side intermediary 320c, network traffic between the client 310c and the server 340c communicated via the secure connection 312b can be intercepted, analyzed, and optimized by the intermediaries 320c and 330c. The client 310c sends network traffic 314a to the server 340c via the newly established secure connection 312b. As secure connection 312b terminates at the client-side intermediary 320c, the client-side intermediary 320c intercepts, decrypts, and processes network traffic 314a to form network traffic 314b.

Client-side intermediary 320c communicates network traffic 314b with the server-side intermediary 330c. In an embodiment, network traffic 314b is communicated via secure connection 316. Server-side intermediary 330c receives optimized network traffic 314b and transforms it into de-optimized network traffic 314c. The de-optimized network traffic 314c may be identical to, or an acceptable substitute for, the network traffic 314a that was originally sent from client 310c. Server-side intermediary 330c communicates the de-optimized network traffic 314c with the server 340c.

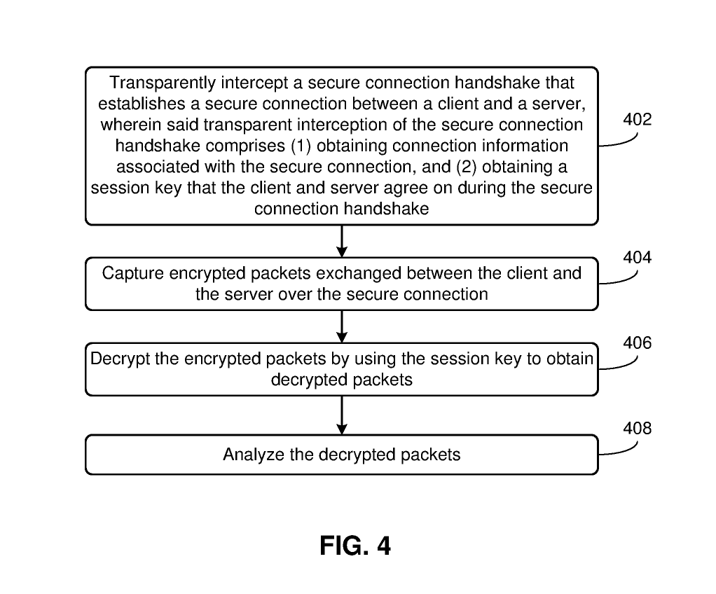

FIG. 4 presents a flowchart that illustrates a process for providing visibility into encrypted traffic without requiring access to the private key in accordance with some embodiments described herein.

The process can begin by transparently intercepting a secure connection handshake that establishes a secure connection between a client and a server, wherein said transparent interception of the secure connection handshake comprises (1) obtaining connection information associated with the secure connection, and (2) obtaining a session key that the client and server agree on during the secure connection handshake (step 402). The connection information and the session key can be stored in a first database so that the session key can be looked up based on the connection information. The connection information and the encrypted packets can be stored in a second database so that the encrypted packets can be looked up based on the connection information.

Next, the process can capture encrypted packets exchanged between the client and the server over the secure connection (step 404). The encrypted packets can then be decrypted by using the session key to obtain decrypted packets (step 406). In some embodiments, decrypting the encrypted packets can comprise (1) retrieving the session key by performing a look up on the first database based on the connection information, (2) retrieving the encrypted packets by performing a look up on the second database based on the connection information, and (3) decrypting the retrieved encrypted packets by using the retrieved session key.

Next, the decrypted packets can be analyzed (step 408). Specifically, analyzing the decrypted packets can comprise searching for content (e.g., words, phrases, documents, audio files, video files, etc.) in the decrypted packets that indicate that the encrypted packets contained confidential information.

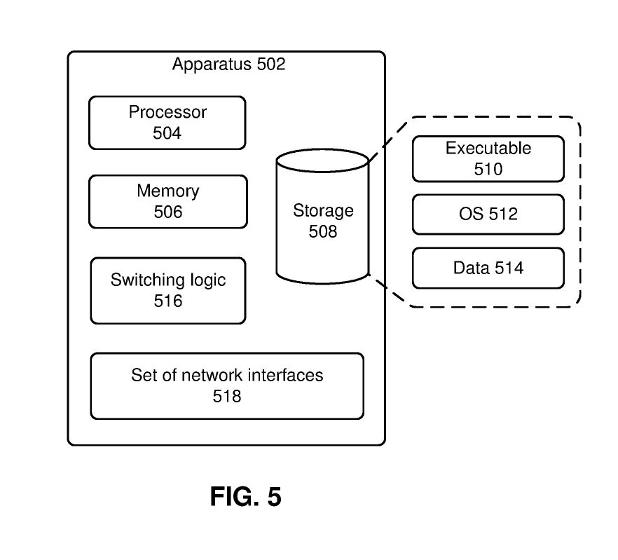

FIG. 5 illustrates an apparatus in accordance with some embodiments described herein. Apparatus 502 (which can be an implementation for a controller) comprises processor 504, memory 506 (e.g., a volatile or non-volatile random access memory), and storage 508 (e.g., a flash memory device or a disk drive). Storage 508 can store executable 510, operating system 512, and data 514. Apparatus 502 also includes switching logic 516 and set of network interfaces 518. The components in apparatus 502 can communicate with one another using a communication mechanism, e.g., a bus, a backplane, and/or a switching fabric.

Executable 510 can include instructions that, when executed by processor 504, cause apparatus 502 to perform one or more methods that are implicitly or explicitly described in this disclosure. Data 514 can include any data that is inputted into or outputted by executable 510. Set of network interfaces 518 can be used to transmit data to and/or receive data from other communication devices. Switching logic 516 can forward network traffic received on one or more network interfaces in accordance with switching/forwarding/routing information stored in apparatus 502. The block diagrams of the architecture and flowcharts are grouped for ease of understanding. However, it should be understood that combinations of blocks, additions of new blocks, re-arrangement of blocks, and the like are contemplated in alternative embodiments of the present invention.

Further embodiments can be envisioned by one of ordinary skill in the art. Combinations or sub-combinations of the subject matter disclosed herein can be advantageously made. The methods and processes described in this disclosure can be partially or fully embodied as code and/or data stored in a non-transitory computer-readable storage medium or device, so that when a computer system reads and executes the code and/or data, the computer system performs the associated methods and processes. The methods and processes can also be partially or fully embodied in hardware modules or apparatuses. Note that the methods and processes can be embodied using a combination of code, data, and hardware modules or apparatuses.

The data structures and code described in this disclosure can be partially or fully stored on a non-transitory computer-readable storage medium and/or a hardware module and/or hardware apparatus. A non-transitory computer-readable storage medium includes all computer-readable storage mediums with the sole exception of a propagating electromagnetic wave or signal. Specifically, a non-transitory computer-readable storage medium includes, but is not limited to, volatile memory, non-volatile memory, magnetic and optical storage devices such as disk drives, magnetic tape, CDs (compact discs), DVDs (digital versatile discs or digital video discs), or other media, now known or later developed, that are capable of storing code and/or data. Hardware modules or apparatuses described in this disclosure include, but are not limited to, application-specific integrated circuits (ASICs), field-programmable gate arrays (FPGAs), dedicated or shared processors, and/or other hardware modules or apparatuses now known or later developed.

The foregoing descriptions of embodiments of the present invention have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention. The scope of the present invention is defined by the appended claims.

What is claimed is:

1. A method for providing visibility into encrypted traffic without requiring access to the private key, the method comprising:
transparently intercepting a secure connection handshake that establishes a secure connection between a client and a server, wherein said transparently intercepting the secure connection handshake comprises:
obtaining connection information associated with the secure connection, and
obtaining a session key that the client and server agree on during the secure connection handshake;
capturing encrypted packets exchanged between the client and the server over the secure connection;
decrypting the encrypted packets by using the session key to obtain decrypted packets; and
analyzing the decrypted packets.

2. The method of claim 1, wherein said analyzing the decrypted packets comprises searching for words or phrases in the decrypted packets that indicate that the encrypted packets contained confidential information.

3. The method of claim 1, comprising storing the connection information and the session key in a first database so that the session key can be looked up based on the connection information.

4. The method of claim 3, comprising storing the connection information and the encrypted packets in a second database so that the encrypted packets can be looked up based on the connection information.

5. The method of claim 4, wherein said decrypting the encrypted packets comprises:
retrieving the session key by performing a look up on the first database based on the connection information; and
retrieving the encrypted packets by performing a look up on the second database based on the connection information.

6. A system for providing visibility into encrypted traffic without requiring access to the private key, the system comprising:
a client-side intermediary to (1) transparently intercept a secure connection handshake that establishes a secure connection between a client and a server, and (2) while transparently intercepting the secure connection handshake, obtain connection information associated with the secure connection;
a server-side intermediary to (1) transparently intercept the secure connection handshake that establishes the secure connection between the client and the server, and (2) while transparently intercepting the secure connection handshake, obtain a session key that the client and server agree on during the secure connection handshake;
a packet capture device to capture encrypted packets exchanged between the client and the server over the secure connection; and
an analysis device to (1) decrypt the encrypted packets by using the session key to obtain decrypted packets, and (2) analyze the decrypted packets.

7. The system of claim 6, wherein the analysis device analyzes the decrypted packets by searching for words or phrases in the decrypted packets that indicate that the encrypted packets contained confidential information.

8. The system of claim 6, wherein the client-side intermediary stores the connection information and the session key in a first database so that the session key can be looked up based on the connection information.

9. The system of claim 8, wherein the packet capture device stores the connection information and the encrypted packets in a second database so that the encrypted packets can be looked up based on the connection information.

10. The system of claim 9, wherein the analysis device decrypts the encrypted packets by:
retrieving the session key by performing a look up on the first database based on the connection information; and
retrieving the encrypted packets by performing a look up on the second database based on the connection information.

11. A set of non-transitory computer-readable storage mediums storing instructions that, when executed by one or more processors, cause the one or more processors to perform a method for providing visibility into encrypted traffic without requiring access to the private key, the method comprising:
transparently intercepting a secure connection handshake that establishes a secure connection between a client and a server, wherein said transparently intercepting the secure connection handshake comprises:
obtaining connection information associated with the secure connection, and
obtaining a session key that the client and server agree on during the secure connection handshake;
capturing encrypted packets exchanged between the client and the server over the secure connection;
decrypting the encrypted packets by using the session key to obtain decrypted packets; and
analyzing the decrypted packets.

12. The set of non-transitory computer-readable storage mediums of claim 11, wherein said analyzing the decrypted packets comprises searching for words or phrases in the decrypted packets that indicate that the encrypted packets contained confidential information.

13. The set of non-transitory computer-readable storage mediums of claim 11, wherein the method comprises storing the connection information and the session key in a first database so that the session key can be looked up based on the connection information.

14. The set of non-transitory computer-readable storage mediums of claim 13, wherein the method comprises storing the connection information and the encrypted packets in a second database so that the encrypted packets can be looked up based on the connection information.

15. The set of non-transitory computer-readable storage mediums of claim 14, wherein said decrypting the encrypted packets comprises:
retrieving the session key by performing a look up on the first database based on the connection information; and
retrieving the encrypted packets by performing a look up on the second database based on the connection information.
